(19) United States
(12) Patent Application Publication
(10) Pub. No.: US 2008/0229872 A1
(43) Pub. Date: Sep. 25, 2008

(54) Adjustable pedal assembly

(75) Inventor: Melinda A. Bray, Jackson, MN (US)

Correspondence Address: TROUTMAN SANDERS LLP, 600 PEACHTREE STREET , NE, ATLANTA, GA, 30308, US

(73) Assignee: AGCO Corporation, Duluth, GA (US)

(21) Appl. No.: 11/726,333

(22) Filed: Mar. 21, 2007

(51) Int. Cl. G05G 1/14

(52) U.S. Cl. 74/560

(57) ABSTRACT

An adjustable pedal assembly including: a lever arm; a mounting bracket located on a first end of the lever arm; an adjustable mounting bracket located on a second end of the lever arm; and an adjustable pedal removably affixed to the adjustable mounting bracket, wherein the adjustable mounting bracket is capable of adjusting a location of the adjustable pedal towards and away from the lever arm, and wherein the adjustable pedal is capable of rotating about the adjustable mounting bracket.

### BACKGROUND OF THE INVENTION

1. Field of the Invention

The present invention relates to an adjustable pedal assembly attached to a vehicle to control the brake, clutch, or throttle in normal operation but which can be adjusted to a different position to accommodate a different driver position.

2. Description of Related Art

Pedal assemblies are provided in vehicles to control brakes, engine throttles, and/or clutches of vehicles. Typically, these pedals assemblies include a lever arm pivotally mounted to a mounting bracket and a pedal pad mounted to a lower end of the lever arm. These pedals are designed to be operated by the foot of the operator of the vehicle. In order for the operator to maintain the most advantageous position for working the control pedals, the vehicle front seat is usually slidably mounted on a seat track and can be moved forwardly or rearwardly between several adjusted positions. In addition, the height of the front seat of the vehicle may be also be adjustable to further allow the operator to maintain the most advantageous position.

Unfortunately, the adjustment provided by moving the seat may not accommodate all vehicle operators due to differences in anatomical dimensions and the limited range of the adjustment of the seat. Another concern involves the placement of a vehicle operator too close to the steering wheel. For example, when the seat is adjusted in a far forward position the risk of injury to the operator during an accident may be substantially increased. Furthermore, not all vehicles are equipped with adjustable seats and therefore require another method for placing the pedals in the most advantageous position for the operator.

Various proposals have been made to provide selective adjustment of pedal positions to accommodate various size operators. Selective pedal adjustment can be accomplished by moving the entire lever arm in forward and rearward directions, or can be accomplished by moving the pedal pad in forward and rearward directions with respect to the lever arm. Examples of an adjustable pedal assemblies are shown in U.S. Pat. Nos. 3,151,499 to Roe, 3,563,111 to Zeigler, and 3,643,524 to Herring. Adjustable pedal assemblies are often complex, difficult to package, and expensive. Additionally, currently available adjustable pedal assemblies can be difficult to assemble and operate.

What is needed therefore is a simplified adjustable pedal assembly that is inexpensive, easy to operate, requires limited packaging space and materials, and which is easily assembled.

### BRIEF SUMMARY OF THE INVENTION

Briefly, described herein is an adjustable pedal assembly including: a lever arm; a mounting bracket located on a first end of the lever arm; an adjustable mounting bracket located on a second end of the lever arm; and an adjustable pedal removably affixed to the adjustable mounting bracket, wherein the adjustable mounting bracket is capable of adjusting a location of the adjustable pedal towards and away from the lever arm, and wherein the adjustable pedal is capable of rotating about the adjustable mounting bracket.

Also disclosed herein is an adjustable pedal assembly including: a lever arm; a mounting bracket affixed to a first end of the lever arm; an adjustable mounting bracket located on a second end of the lever arm including: a receiving member affixed to the second end of the lever arm; a mounting member removably affixed to the receiving member; and an adjustable pedal removably affixed to the mounting member by a support rod and an attachment rod, wherein the mounting member is slidably affixed to the receiving member in a manner operable for adjusting a location of the adjustable pedal towards and away from the lever arm, and wherein the adjustable pedal is capable of rotating about the attachment rod.

These and other objects, features and advantages of the present invention will become more apparent upon reading the following specification in conjunction with the accompanying drawing figures.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an schematic view of adjustable pedal assembly in accordance with exemplary embodiments of the present invention;

FIG. 2 illustrates an the adjustable pedal assembly in accordance with exemplary embodiments of the present invention; and

FIG. 3 illustrates the adjustable pedal assembly in accordance with exemplary embodiments of the present invention.

The detailed description explains the preferred embodiments of the invention, together with advantages and features, by way of example with reference to the drawings.

### DETAILED DESCRIPTION OF THE INVENTION

Disclosed herein is an adjustable pedal assembly including: a lever arm; a mounting bracket located on a first end of the lever arm; an adjustable mounting bracket located on a second end of the lever arm; and an adjustable pedal removably affixed to the adjustable mounting bracket, wherein the adjustable mounting bracket is capable of adjusting a location of the adjustable pedal towards and away from the lever arm, and wherein the adjustable pedal is capable of rotating about the adjustable mounting bracket.

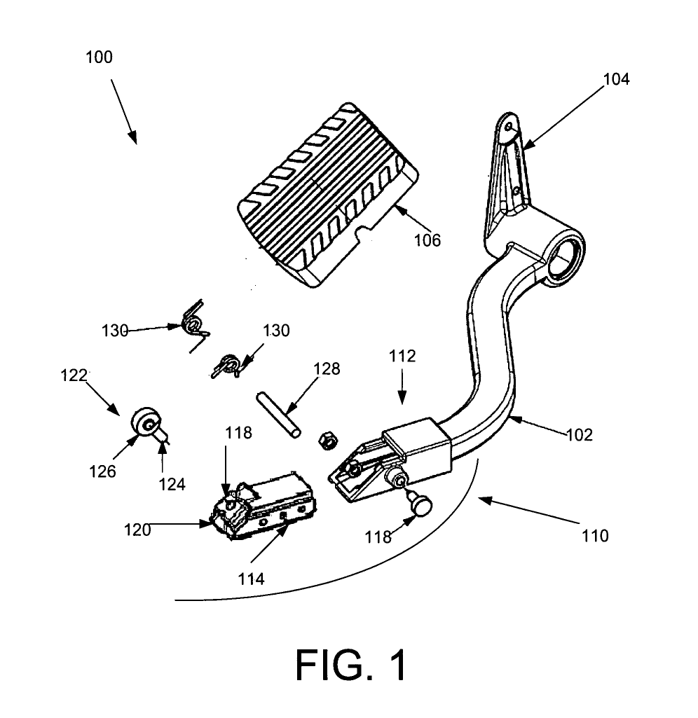

Referring now to FIG. 1, an adjustable pedal assembly in accordance with exemplary embodiments is depicted generally as 100. The adjustable pedal assembly 100 includes a lever arm 102 with a mounting bracket 104 located on one end of the lever arm 102 and an adjustable pedal 106 is located on the opposing end of the lever arm 102. The mounting bracket 104 is designed to connect the adjustable pedal assembly 100 to a vehicle and it may include one or more apertures for bolting the mounting bracket 104 to the vehicle. In exemplary embodiments, the lever arm 102 and the mounting bracket 104 may be constructed out of a suitably rigid and durable material such as steel, aluminum, or the like.

The adjustable pedal assembly 100 allows an operator of a machine to adjust the position of the adjustable pedal 106 towards and away from the operator without adjusting the position of the lever arm 102. Additionally, the adjustable pedal 106 is capable of rotating approximately ten to twenty degrees to accommodate various size operators. In exemplary embodiments, the adjustable pedal 106 is affixed to the lever arm 102 with an adjustable mounting bracket 110. The adjustable mounting bracket 110 is designed to allow the adjustable pedal 106 to be translated fore and aft while the lever arm 102 remains in a constant position and to allow the adjustable pedal 106 to rotate or pivot. In an exemplary embodiment, the adjustable pedal 106 may rotate or pivot by up to approximately thirty degrees in each direction from its normal resting position.

The adjustable mounting bracket 110 includes a receiving member 112 designed to receive a mounting member 114. The mounting member 114 may be slideably disposed in the receiving member 112, allowing the mounting member 114 to be translated fore and aft in relation to the receiving member 112. In another exemplary embodiment, the mounting member 114 may be slidably disposed over the receiving member 112. In exemplary embodiments, the position of the mounting member 114 is selectively fixed relative to the receiving member 112 by a connection device 118.

In exemplary embodiment, the connection device 118 may be a pin designed to extend at least partially through one or apertures 116 disposed on the mounting member 114 and the receiving member 112. In another exemplary embodiment, the connection device 118 may be a clamp or compression ring that is disposed over the receiving member 112 and the mounting member 114 and is operable to selectively fix the relative position of the two. In yet another exemplary embodiment, the connection device 118 may be a nut and bolt designed to extend through apertures 116. In one embodiment, the connection device 118 may be affixed to the receiving member 112 with a spring that is used to control the position of the connection device 118. For example, the connection device 118 may be a pin connected to the receiving member 112 by a spring such that it engages the mounting member 114 unless a force is exerted on the spring to disengage the pin from the mounting member 114, thereby allowing the position of the mounting member to be adjusted. In another exemplary embodiment, the connection device 118 may be a bolt that is extends through the receiving member 112 and contacts the mounting member 114. The bolt may exert a force on the mounting member 114 suitable to secure the position of the mounting member 114 or the bolt may be threaded into one or more recesses on the mounting member 114. In yet another exemplary embodiment, the connection device 118 may be affixed to the mounting member 114 by a spring and the receiving member 112 could have a plurality of apertures that the connection device 118 may extend through. The above configurations of the mounting member 114, the receiving member 112, and the connection device 118 are provide for illustrative purposes only and are not intended to be an exhaustive list of possible configurations within the scope of the present invention.

In exemplary embodiments, the mounting member 114 includes an inclined outer-face that is located opposite the end of the mounting member 114 that affixes to the receiving member 112. The angle of the incline of the inclined outer-face may be selected from a wide range of angles and is approximately the same as the desired inclination angle that the adjustable pedal 106. The mounting member 114 includes an aperture 118 and one or more restrictor portions 120 that may be located on the inclined outer-face of the mounting member 114. The restrictor portions 120 on the mounting member 114 are designed to restrict the freedom of rotation of the adjustable pedal 106 and may be disposed on opposing sides of the aperture 118.

In exemplary embodiments, a support rod 122 is inserted into the aperture 118 on the outer-face of the mounting member 114. The support rod 122 includes an elongated portion 124 designed to fit into aperture 118 and a support portion 126. The support portion 126 has a generally circular shape and is designed for receiving an attachment rod 128. The attachment rod 128 extends through an aperture disposed in the support portion 126 and is approximately perpendicular to the elongated portion 124. The attachment rod 128 is also designed to extend through a portion of the adjustable pedal 106, such that it rotateably affixes the adjustable pedal 106 to the mounting member 114.

In exemplary embodiments, a spring may be used to bias the position of the adjustable pedal 106. The spring may be a torsional spring 130 that is disposed on the attachment rod 128. In one embodiment, two torsional springs 130 are disposed on the attachment rod 128 and are used to bias the position of the adjustable pedal 106. The adjustable pedal 106 rotates or pivots from its resting, or biased position, by up to thirty degrees in each direction due to a force exerted by a user. Additionally, the attachment rod 128 may include one or more retention devices 132 that are designed to prevent the torsional springs 130 from sliding off of the attachment rod 128. For example, the retention devices 132 may be pins, clips, or nuts placed on the ends of the attachment rod 128 that are suitable for preventing the torsional springs 130 from sliding off of the attachment rod 128.

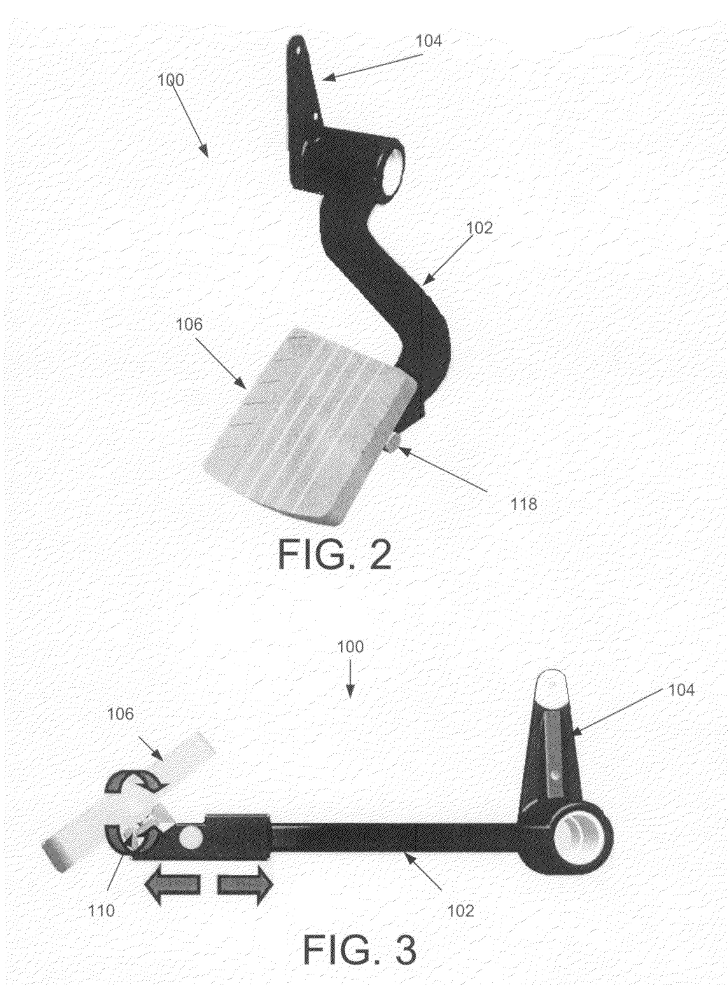

FIGS. 2 and 3 illustrate other exemplary embodiments of the adjustable pedal assembly 100. FIG. 3 illustrates the directions that the adjustable pedal 106 is able to move relative to the lever arm 102. As shown, the lever arm may be straight or may have a curved shape.

While the exemplary embodiments of the invention have been described, it will be understood that those skilled in the art, both now and in the future, may make various improvements and enhancements, which fall within the scope of the claims that follow. These claims should be construed to maintain the proper protection for the invention first described.

What is claimed is:

1. An adjustable pedal assembly comprising:
a lever arm;
a mounting bracket located on a first end of the lever arm;
an adjustable mounting bracket located on a second end of the lever arm; and
an adjustable pedal removably affixed to the adjustable mounting bracket,
wherein the adjustable mounting bracket is capable of adjusting a location of the adjustable pedal towards and away from the lever arm, and
wherein the adjustable pedal is capable of rotating about the adjustable mounting bracket up to approximately thirty degrees from a resting position.

2. The adjustable pedal assembly of claim 1, wherein a spring biases a position of the adjustable pedal relative to the adjustable mounting bracket.

3. The adjustable pedal assembly of claim 2, wherein the spring is a torsional spring.

4. The adjustable pedal assembly of claim 1, wherein the adjustable mounting bracket includes a receiving member affixed to the second end of the lever arm, the receiving member including a recess.

5. The adjustable pedal assembly of claim 4, wherein the adjustable mounting bracket further includes a mounting member slidably disposed in the recess of the receiving member, wherein the mounting member is selectively secured to the receiving member.

6. The adjustable pedal assembly of claim 5, wherein the adjustable pedal is removably affixed to the mounting member.

7. An adjustable pedal assembly comprising:
a lever arm;
a mounting bracket affixed to a first end of the lever arm;
an adjustable mounting bracket located on a second end of the lever arm comprising:
a receiving member affixed to the second end of the lever arm;
a mounting member removably affixed to the receiving member; and
an adjustable pedal removably affixed to the mounting member by a support rod and an attachment rod,
wherein the mounting member is slidably affixed to the receiving member in a manner operable for adjusting a location of the adjustable pedal towards and away from the lever arm, and
wherein the adjustable pedal is capable of rotating about the attachment rod.

8. The adjustable pedal assembly of claim 7, a spring biases the position of the adjustable pedal relative to the mounting member.

9. The adjustable pedal assembly of claim 8, wherein the spring is a torsional spring disposed on the attachment rod.

10. The adjustable pedal assembly of claim 7, further comprising a connection member that selectively fixes a position of the mounting member is relative to the receiving member.

11. The adjustable pedal assembly of claim 10, wherein the connection member includes a pin that extends through at least partially through an aperture in the mounting member and an second aperture in the receiving member.

12. The adjustable pedal assembly of claim 10, wherein the connection member is a compression ring.
